(19) United States
(12) Patent Application Publication
(10) Pub. No.: US 2020/0011113 A1
(43) Pub. Date: Jan. 9, 2020

(54) MODULAR DOORS

(71) Applicant: Durr UNIVERSAL, Inc., Stoughton, WI (US)

(72) Inventors: Adam Joseph Shambeau, Stoughton, WI (US); Matthew Mark Holschuh, Fitchburg, WI (US); Dean Joseph Abing, Stoughton, WI (US); Steven James Honerlaw, Stoughton, WI (US)

(21) Appl. No.: 16/455,119

(22) Filed: Jun. 27, 2019

Related U.S. Application Data
(60) Provisional application No. 62/694,267, filed on Jul. 5, 2018.

(51) Int. Cl. E06B 1/52; E06B 7/22; E06B 3/70

(52) U.S. Cl. CPC E06B 1/52; E06B 1/12; E06B 3/70; E06B 7/22

(57) ABSTRACT

Modular doors are disclosed. A disclosed example apparatus includes a door frame for insertion into a door opening of a support structure. The door frame includes a first side member to be parallel with a plane of the door opening when the door frame is inserted into the door opening, and a second side member angled from the first side member at a bend. The second side member has a first side to face the support structure when the door frame is inserted into the door opening. The second side member has a second side opposite the first side to face the door opening when the door frame is inserted into the door opening.

### RELATED APPLICATION

This patent claims priority to, and the benefit of, U.S. Provisional Patent Application Ser. No. 62/694,267, which was filed on Jul. 5, 2018. U.S. Provisional Patent Application Ser. No. 62/694,267 is hereby incorporated herein by reference in its entirety.

### FIELD OF THE DISCLOSURE

This disclosure relates generally to door installation/replacement, and, more particularly, to modular doors.

### BACKGROUND

Access doors in industrial applications (e.g., factories, outdoor enclosures, production facilities, etc.) can be subject to wear, deterioration and/or corrosion. As a result, these doors can require relatively frequent replacement and/or repair, all of which can be costly. Further, removal of these doors can reveal numerous flaws and/or imperfections (e.g., due to warping, deterioration, corrosion, damage etc.) of a support structure that mounts and supports the doors.

Installing replacement doors onto the aforementioned support structure can be difficult due to the flaws and/or imperfections with the support structure. As a result, significant expense and labor cost can be involved in replacing the doors. Further, an inoperative door in an industrial facility can result in significant and costly downtime or even reduce operational efficiency.

### BRIEF DESCRIPTION OF THE DRAWINGS

FIG. 1 is an exploded view depicting an example door assembly in accordance with teachings of this disclosure.

FIG. 2A is a front view of the example door assembly of FIG. 1.

FIG. 2B is a cross-sectional view along a line A-A of FIG. 2A.

FIG. 2C is a detailed view of a region A of FIG. 2B.

FIGS. 3 and 4 are detailed cross-sectional views of a door frame of the example door assembly of FIGS. 1-2C.

FIGS. 5A and 5B illustrate an example installation process in accordance with teachings of this disclosure.

FIG. 6 is a flowchart representative of an example method to implement examples disclosed herein.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Modular doors are disclosed. For industrial applications, installing replacement doors onto a support structure (e.g., a wall, a partial wall, a surface of a component, a rack, a fixture, an opening, etc.) can be relatively difficult due to warping, unevenness, irregularities and/or deterioration of the support structure. As a result, significant expense, time and labor cost can be involved in replacing these doors.

Examples disclosed herein provide a cost-effective solution to industrial door installations or replacements. Examples disclosed herein facilitate ease of installation of a door assembly onto a door opening of a support structure. Examples disclosed utilize a door frame with a perimeter to be inserted into the door opening. The perimeter of the aforementioned door frame exhibits a cross-sectional profile including first and second side members angled from one another, thereby defining a flanged profile (e.g., an 1-shaped flange profile, etc.). When the door frame is installed onto the door opening, the first side member is oriented to be parallel with a door plane associated with the door opening and the second side member includes first and second sides. The first side faces the support structure when door frame is placed onto the support structure. The second side faces the door opening

Due to the cross-sectional profile of the perimeter, the door frame can be easily installed onto the door opening while accommodating any potential warping, dimensional inconsistencies and/or manufacturing variations of the door opening and/or the surrounding support structure, thereby reducing (e.g., significantly eliminating) time that would be, otherwise, be spent trying to adjust a frame or a door assembly to this door opening. In other words, examples disclosed herein can be adaptable for relatively large tolerances and, thus, have significant installation flexibility. Further, examples disclosed herein can be relatively lightweight and inexpensive to manufacture.

In some examples, the second side member is deformable and further bent toward a portion of the support structure. In particular, the second side member is bent from its preliminary default angle (e.g., a default manufactured angle) from the first side member to contact a portion of the support structure. Additionally or alternatively, a portion of the support structure is bent toward at least one of the first or second side members. In some examples, the door is sealed to the door frame. In some examples, the door and/or the door frame is at least partially composed of carbon steel.

As used herein, the term “door” refers to an assembly, device and/or component that operates as a door (and any appropriate functional equivalents), which can be opened and closed to enable persons and/or objects to travel therethrough. Accordingly, the term “door” can encompass a door with or without a lock, as well as a door with or without a latch. Further, the term “door” may also encompass a hinge and/or a portion of a hinge associated with rotation thereof. As used herein, the term “side member” can refer to an edge, a surface, a contour and/or a wall. As used herein, the term “angled” in the context of multiple walls, side members and/or edges refers to an angle in which the walls and/or edges extend (e.g., longitudinally extend) relative to one another. Further, the term “angled” does not refer to objects that are angled at 0 degrees from one another. As used herein, stating that objects or surfaces are “parallel” means that the objects or surfaces are oriented within 10 degrees from one another.

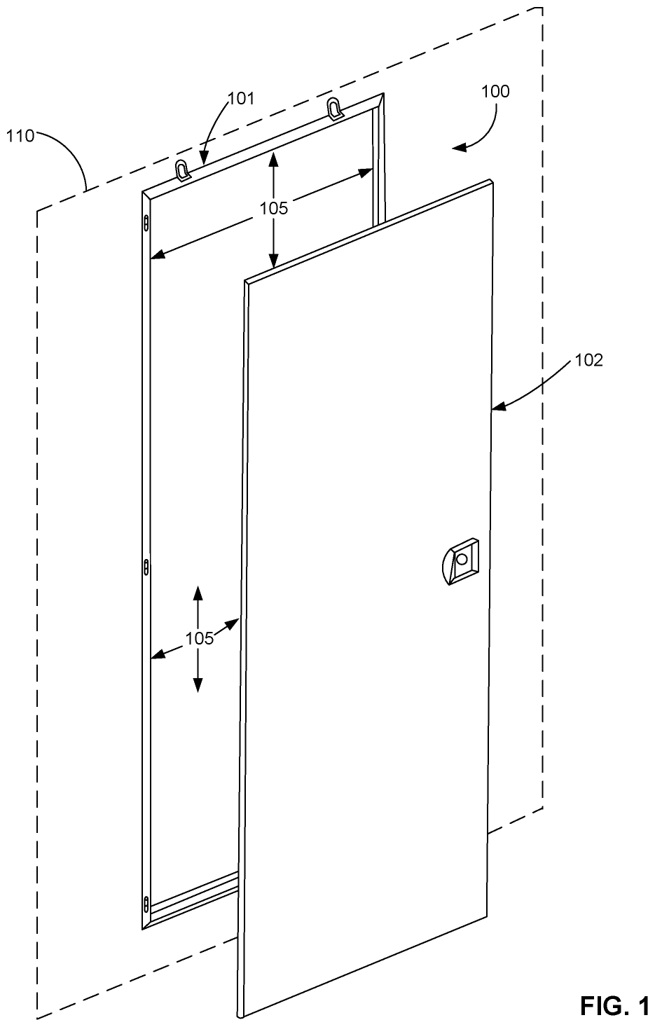

FIG. 1 is an exploded view depicting an example door assembly (e.g., a door installation assembly, a door module, a modular door assembly, etc.) 100 in accordance with teachings of this disclosure. The door assembly 100 of the illustrated example includes a door frame (e.g., a modular door frame, an adaptable door frame, etc.) 101 and a door (e.g., a door assembly, a hinged door, etc.) 102. The example door frame 101 defines a door opening (e.g., an opening volume, an opening region, an internal volume, etc.) 105. Further, the door opening 105 of the door frame 101 defines a door plane (e.g., a door frame plane, a door opening plane) 110, as can be seen in the example of FIG. 1.

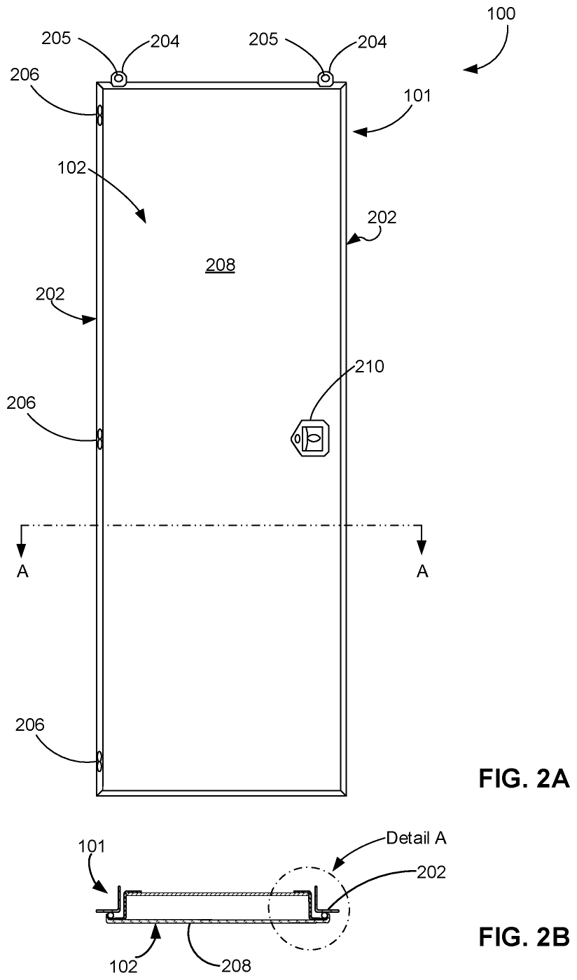

As will be discussed in greater detail below in connection with FIGS. 2A-6, examples disclosed enable relatively easy and cost-effective installation or replacement of a door. In particular, the door frame 101 is suited for placement onto openings of walls that are subject to warping, damage and/or misalignment, all of which can be common in industrial environments. However, examples disclosed herein are not limited to industrial environment or applications and can be applied to any appropriate use or environment involving installation or replacement of a door.

FIG. 2A is a front view of the example door installation assembly 100 of FIG. 1. As can be seen in FIG. 2A, the door 102 is shown assembled to the door frame 101. In the illustrated example of FIG. 2A, support structures holding and mounting the door frame 101 and the door 102 are omitted for clarity.

In the illustrated example, the door frame 101 includes a perimeter (e.g., a contact perimeter, a coupling perimeter, a ring mount, etc.) 202, and mounts 204 with corresponding apertures 205, which can be used to facilitate lifting and placing the door frame 101. At least one of the door 102 or the door frame 101 of the illustrated example includes hinges 206. Further, the example door 102 includes a body (e.g., a main surface body) 208 and a door handle (e.g., a door handle mechanism, a door lock, a door latch, a single point cam latch, etc.) 210.

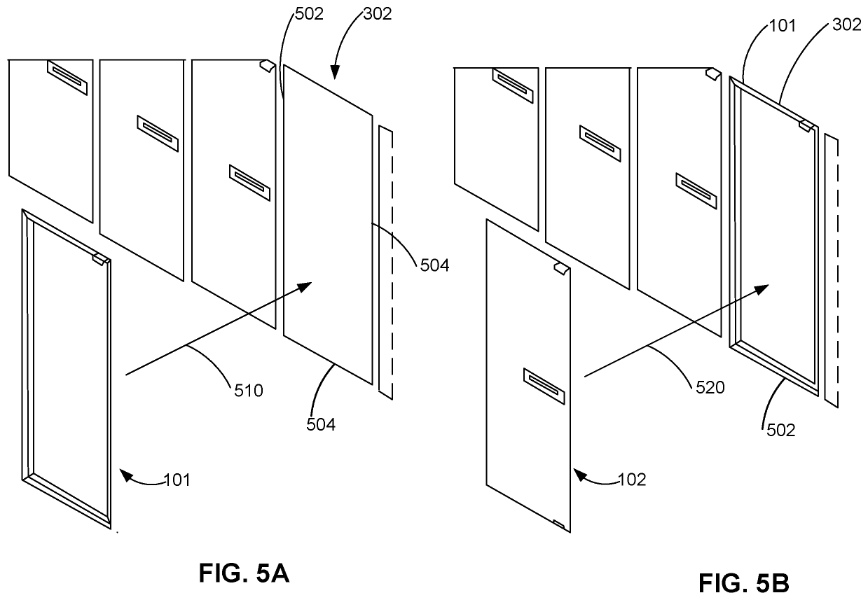

The perimeter 202 of the illustrated example is inserted into a door opening 502 with corresponding edges 504 (shown in FIGS. 5A and 5B). In particular, when the frame 101 is placed into the opening 502, the perimeter 202 is disposed between a periphery of the door 102 and the edges 504 of the door opening 502. In this example, the perimeter 202 is shaped to generally align to the door opening 502 and/or the edges 504 to facilitate insertion of the door frame 101 into the opening 502. Additionally or alternatively, the perimeter 202 is bent and/or shaped to match a geometry of the opening 502.

The frame 101 of the illustrated example can be attached to the opening 502 in multiple ways. The frame 101 can have apertures (e.g., pre-drilled apertures) for fasteners (e.g., bolds, rivets, etc.). In some examples, the frame 101 includes self-drilling fasteners. Additionally or alternatively, the frame 101 could have an adhesive, gaskets and/or sealants coupled thereto for installation (e.g., can be applied before or during installation). In some examples, the frame 101 is welded to the opening 502 and/or the support structure 302. Any combination of the above can be implemented.

In some examples, the hinges 206 operatively couple the door 102 to the door frame 101 (e.g., both the door 102 and the door frame 101 include portions or sub-components of the hinges 206). In some examples, the hinges 206 are part of the door 102 (e.g., the door 102 has stationary mounts or flanges to be coupled to the door frame 101). However, any appropriate hinge arrangement can be employed instead. In examples where the hinges 206 are placed and/or assembled to the door frame 101, the door frame 101 can be locally strengthened and/or reinforced to reduce a probability of a change in relative spacing and/or orientation between the hinges 206 that could result in misalignment and/or difficult assembly of the door 102.

FIG. 2B is a cross-sectional view along a line A-A of FIG. 2A. As can be seen in FIG. 2B, the body 208 of the door 102 extends past the perimeter 202 of the door frame 101. In other examples, however, the body 208 does not extend past the perimeter 202 (e.g., the body 208 is flush with the perimeter 202). In the illustrated example, the door 102 includes numerous sub-panels and/or sub-structures.'

FIG. 2C is a detailed view of a region A of FIG. 2B. In the illustrated example, the perimeter 202 of the door frame 101 is shown relative to the door 102. In particular, the door 102 is depicted installed onto the door frame 101 in the view of FIG. 2C. Further, in this example, the door frame 101 has not been adjusted and/or bent (e.g., by plastic deformation) toward the opening 502 and, thus, remains in its default shape (e.g., pre-bent or manufactured shape).

To facilitate mounting the door frame 101 to the opening 502 shown in FIGS. 5A and 5B, the perimeter 202 of the illustrated example includes a cross-sectional profile 220 that extends along a longitudinal length of the perimeter 202. The cross-sectional profile 220 includes a first side member (e.g., a first wall, a first edge) 222 and a second side member (e.g., a second wall, a second edge) 224 angled from the first side member 222 at a bend (e.g., a pivot) 226. In this example, the first and second side members 222, 224 define a generally 1-shaped flanged profile. The first and second side members 222, 224 may be perpendicular to one another. However, in other examples, the first and second side members 222, 224 may be angled at any appropriate angle (e.g., 30 degrees, 45 degrees, 60 degrees, etc.). Accordingly, as a result of the first and second side members 222, 224 being angled to one another, the door frame 101 exhibits a relatively high strength to weight ratio. In this example, the first and second side members 222, 224 are relatively flat. However, in other examples, the first and second side members 222, 224 may be relatively bent and/or curved in shape in the cross-sectional profile 220. In this example, the first side member 222 is parallel (e.g., within 10 degrees of) with the door plane 110 shown in FIG. 1.

The door 102 of the illustrated example includes an outer wall 230 having a bent portion 231, an inner wall 232, a frame (e.g., a flange) 234 having a lateral wall or portion 236 and outer panel 240. In particular, the outer wall 230, the inner wall 232, the frame 234 and the lateral wall 236 and the outer panel 240 define a generally enclosed structure of the door 102.

To seal and/or couple the door 102 to the door frame 101, a seal (e.g., a sealant, a caulk, a weather-tight seal, a compressible seal, etc.) 242 is placed between the outer panel 240 of the door 102 and the first side member 222 of the door frame 101. In this example, the seal 242 is at least partially aligned by the bent portion 231 and compressed between the outer panel 240 and the first side member 222. Additionally or alternatively, an adhesive is placed between the outer panel 240 and the first side member 222.

In some examples, at least one of the door frame 101 or the door 102 is at least partially composed of carbon steel. (e.g., painted carbon steel). However, any appropriate material may be implemented instead. In some examples, the first side member 222 and/or the second side member 224 are approximately 1-3 inches (″) (e.g., 2″) in length. Additionally or alternatively, the door 102 has an inner liner at least partially composed of perforated steel. In some other examples, the door 102 is implemented as a double door, instead.

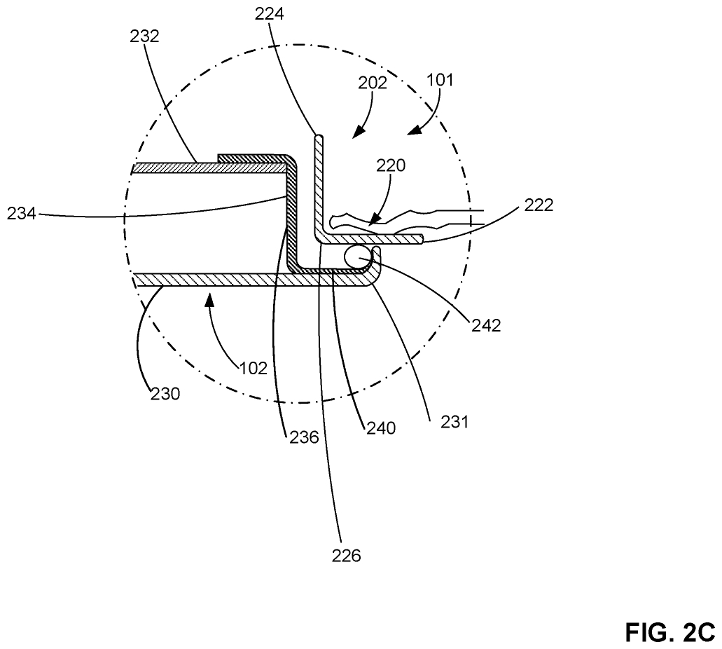

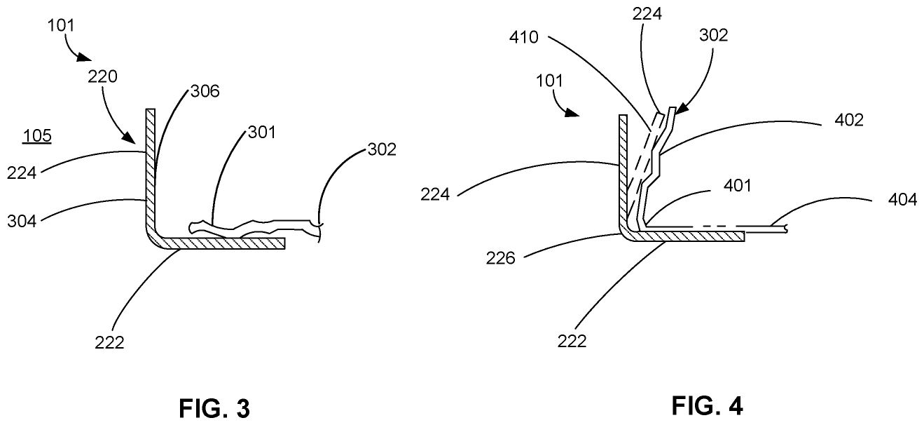

FIGS. 3 and 4 are detailed cross-sectional views of the door frame 101 of the example door assembly (e.g., a door system) 100 of FIGS. 1-2C. Turning to FIG. 3, a portion 301 of a support structure 302 is shown relative to the cross-sectional profile 220 of the door frame 101. In this example, the portion 301 of the support structure 302 generally extends toward the second side member 224, but generally contacts and/or is in proximity of the first side member 222.

In the illustrated example, the second side member 224 has a first side 304 facing the door opening 105 when the door frame 101 is placed and/or installed in the support structure 302. Further, the second side member 224 has a second side 306 that is opposite the first side 304 and facing toward the support structure 302 when the door frame is placed and/or installed in the support structure 302. In other words, the frame 101 generally resembles an 1-shaped flange to mount to and/or surround the opening 502 (shown in FIGS. 5A and 5B) of the support structure 302. In some examples, the cross-sectional profile 220 represents discrete segments and/or the individual edges 504 of the opening 502. In some such examples, the cross-sectional profile 220 does not extend past a corner (i.e., does not extend past an edge intersection between the edges 504) of the opening 502, thereby facilitating bending of the second side member 224 at the individual edges 504 of the opening 502. For example, the side members 224 at each of the edges 504 are not coupled to one another and, thus, a gap and/or indentation is positioned therebetween. Additionally or alternatively, the cross-sectional profile 220 represents individual discrete segments of the edges 504 of the opening 502 (e.g., flange segments with lengths shorter than the respective edges 504 of the opening 502).

In some examples, the portion 301 is coupled to the first side member 222 and/or the second side member 224. For example, the portion 301 can be adhered, welded and/or attached to the first side member 222. In some particular examples, the support structure 302, the opening 502 and/or the edges 504 is applied with an adhesive prior to the door frame 101 being inserted into the opening 502 (shown in FIGS. 5A and 5B). Additionally or alternatively, the door frame 101 is held onto the opening 502 (e.g., initially held before being bent relative to the opening 502) via an interference fit, such that the support structure 302 interferes with at least a portion of the door frame 101 when the frame 101 is placed into the opening 502.

Turning to FIG. 4, an example in which at least one of the second side member 224 or the support structure 302 is adjusted (e.g., bent, angled, plastically deformed, etc.) is shown. For example, at least one of the second side member 224 or the support structure 302 is deformable and can be bent after placement of the frame 101 into the opening 502 so that the second side member 224 contacts and/or transmits a force (e.g., a static force) to the support structure 302.

In the illustrated example, the support structure 302 has been bent at a pivot point 401 to define a bent portion 402 and a base portion 404. Further, the second side member 224 is bent relative to the first side member 222 at the aforementioned bend 226, thereby defining a bent portion 410. In particular, the bent portion 410 is defined during installation of the door frame 101 onto the opening 502. In some examples, the second side member 224 is bent together (e.g., simultaneously) with the support structure 302 to define the bent portions 410, 402, both of which can be further coupled together (e.g., via adhesive, a welding process, etc.). In some such examples, a single tool and/or process is used to define the bent portions 410, 402.

FIGS. 5A and 5B illustrate an example installation process in accordance with teachings of this disclosure. Turning to FIG. 5A, the door frame 101 is depicted being inserted into the aforementioned opening 502 of the support structure 302, as generally indicated by an arrow 510. In this example, the installation of the door frame 101 onto the facilitates ease of installation of the door 102 by accommodating imperfections, warping and/or misalignment associated with the opening 502. Further, the aforementioned edges 504 are shown defining a general shape or outline of the opening 502.

Turning to FIG. 5B, the door frame 101 has been inserted into the opening 502 of the support structure 302. As generally indicated by an arrow 520, the door 102 is mounted to the door frame 101. In this example, the door frame 101 is mounted to the door 102 via the hinges 206 shown in FIG. 2.

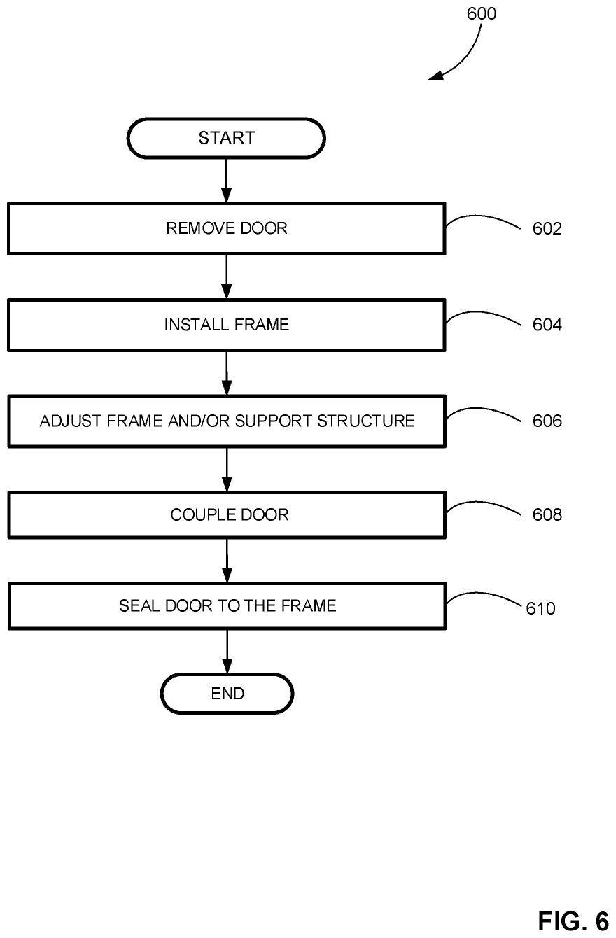

FIG. 6 is a flowchart representative of an example method 600 to implement examples disclosed herein. In this example, the door 102 is being installed to replace a pre-existing door currently placed in the opening 502. However, in other examples, the door 102 can be installed onto a new installation with the opening 502 (e.g., the opening 502 is not associated with a pre-existing door).

At block 602, the pre-existing door is removed from the opening 502. In particular, the pre-existing door can be damaged from industrial use. The opening 502 may be defined by cutting out the pre-existing door and/or an associated support structure of the pre-existing door for ease of removal, thereby reducing an amount of effort involved in removing the existing door structure.

At block 604, the door frame 101 is installed onto the support structure 302. In this example, the door frame 101 is inserted into the opening 502 of the support structure 302. In some examples, the opening 502 is enlarged and/or adjusted (e.g., cut, bent, re-oriented, etc.) to accommodate the door frame 101.

At block 606, in some examples, the door frame 101 and/or the support structure 302 is adjusted. For example, at least one of the door frame 101 or the support structure 302 is bent to accommodate imperfections and/or warping of the support structure 302 and/or to secure the door frame 101 to the opening 502. Additionally or alternatively, the opening 502 is adjusted (e.g., enlarged, reshaped, etc.) to facilitate insertion of the door frame 101.

At block 608, the door 102 is coupled to the door frame 101. In some examples, the hinge 206 couples the door frame 101 to the door 102. In other examples, the door 102 is implemented as an assembly, which includes pre-assembled hinges and a mount to attach to the door frame 101.

In some examples, at block 610, the door 102 is sealed to the door frame 101 and the process ends. For example, the seal 242 is placed and compressed between the door 102 and the door frame 101. Additionally or alternatively, at least a portion of the door 102 can be welded to the door frame 101. In some examples, a sealing gasket, caulk and/or sealant is employed to define a seal between the door frame 101 and the door 102.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

From the foregoing, it will be appreciated that example methods, apparatus and articles of manufacture have been disclosed that enable door replacements (or installations) that can accommodate warping, tolerance mismatch, damage (e.g., due to industrial applications and processes) and/or manufacturing/installation error. As a result, significant time, cost and labor can be reduced. Further, examples disclosed herein enable light door structures with relatively high strength.

This patent claims priority to, and the benefit of, U.S. Provisional Patent Application Ser. No. 62/694,267, which was filed on Jul. 5, 2018. U.S. Provisional Patent Application Ser. No. 62/694,267 is hereby incorporated herein by reference in its entirety.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A door frame for insertion into a door opening of a support structure, the door frame comprising:
a first side member to be parallel with a plane of the door opening when the door frame is inserted into the door opening, and
a second side member angled from the first side member at a bend, the second side member having a first side to face the support structure when the door frame is inserted into the door opening, the second side member having a second side opposite the first side to face the door opening when the door frame is inserted into the door opening.

2. The door frame as defined in claim 1, further including a third side member having a third side to face the support structure and a fourth side opposite the third side to face the door opening when the door frame is inserted into the opening.

3. The door frame as defined in claim 2, wherein the third side member and the second side member are separated by a gap therebetween.

4. The door frame as defined in claim 1, further including a seal to seal the door frame to at least a portion of a door to be coupled to the door frame.

5. The door frame as defined in claim 1, wherein the second side member is angled to contact the support structure.

6. The door frame as defined in claim 5, wherein at least a portion of the support structure is bent to contact the second side member.

7. The door frame as defined in claim 1, wherein the first and second side members define an 1-shaped flange profile.

8. A door system for use with a door opening of a support structure, the door system including:
a door frame for insertion into the door opening, the door frame having a first side member and a second side member angled from the first side member at a bend, the first side member to be parallel to a plane of the opening when the door frame is inserted into the door opening, the second side member having a first side to face the support structure when the door frame is inserted into the door opening, the second side member having a second side opposite the first side to face the door opening when the door frame is inserted into the door opening; and
a door to be operatively coupled to the door frame after the door frame is inserted into the door opening.

9. The door system as defined in claim 8, further including a seal disposed between the door and the door frame.

10. The door system as defined in claim 9, wherein the seal is compressed between the door and the door frame.

11. The door system as defined in claim 8, further including a third side member having a third side to face the support structure and a fourth side opposite the third side to face the door opening when the door frame is inserted into the opening.

12. The door system as defined in claim 8, wherein the second side member is deformable so that the second side member can be bent toward the support structure to contact the support structure.

13. The door system as defined in claim 12, wherein a portion of the support structure is bent toward the second side member.

14. The door system as defined in claim 13, wherein the portion of the support structure and the second side member are bent at the same angle from the plane of the door opening.

15. A method comprising:
coupling a door frame to a door opening of a support structure, wherein the door frame includes a first side member and a second side member angled from the first side member at a bend, wherein the first side member is to be parallel with a plane defined by the door opening when the door frame is coupled to the door opening, the second side member having a first side to face the support structure when the door frame is inserted into the door opening, the second side member having a second side opposite the first side to face the door opening when the door frame is inserted into the door opening; and
coupling a door to the door frame.

16. The method as defined in claim 15, further including bending the second side member to contact the support structure.

17. The method as defined in claim 16, further including bending a portion of the support structure with the second side member to bring the second side member in contact with the portion of the support structure.

18. The method as defined in claim 15, further including bending at least a portion of the support structure to contact at least one of the first or second side members.

19. The method as defined in claim 15, further including cutting around an existing door structure to define the door opening.

20. The method as defined in claim 15, further including defining or placing a seal between the door frame and door.
